(19) United States
(12) Patent Application Publication
(10) Pub. No.: US 2004/0168710 A1
(43) Pub. Date: Sep. 2, 2004

(54) Cleaning solution and method of cleaning a semiconductor substrate using the same

(76) Inventors: Sang-Mi Lee, Suwon-city (KR); Jin-Ho Hwang, Suwon-city (KR); Il-Hyun Sohn, Suwon-city (KR)

Correspondence Address: VOLENTINE FRANCOS, P.L.L.C., Suite 150, 12200 Sunrise Valley Drive, Reston, VA, 20191, US

(21) Appl. No.: 10/774,383

(22) Filed: Feb. 10, 2004

(30) Foreign Application Priority Data
Feb. 27, 2003 (KR) 2003-12428

(51) Int. Cl. B08B 7/00

(52) U.S. Cl. 134/19; 134/26; 134/28

(57) ABSTRACT

Disclosed are a cleaning solution and a method of cleaning a semiconductor substrate using the same without damaging the substrate. The cleaning solution includes from about 10% to about 35% by weight of hydrogen fluoride (HF), from about 10% to about 35% by weight of ammonium fluoride (NH₄F) and from about 30% to about 80% by weight of de-ionized water (H₂O). A nitride layer at a side or bottom portion of the substrate, or on a control substrate can be rapidly removed using the cleaning solution.

### BACKGROUND OF THE INVENTION

1. Field of the Invention

The present invention relates to a cleaning solution and to a method of cleaning a semiconductor substrate using the same. More particularly, the present invention relates to a cleaning solution for and to a method of removing a nitride layer adhered to a bevel portion or a bottom portion of a semiconductor substrate.

2. Description of the Related Art

Generally, a semiconductor device is formed by repeatedly carrying out unit processes including deposition, photolithography, etching, chemical mechanical polishing, cleaning, and drying processes, etc. Of these unit processes, the cleaning process is carried out to remove impurities from a surface of the semiconductor substrate or to remove unnecessary layers therefrom. Recently, the cleaning process has gained in importance in the overall semiconductor device manufacturing process, especially as the patterns formed on the semiconductor substrates decrease in size, and as the aspect ratios of openings in layers on the semiconductor substrates become larger.

Meanwhile, today's semiconductor memory devices often comprise an interlayer dielectric provided between two conductive layers, a contact hole extending through the dielectric layers, and a contact plug disposed in the contact hole to connect the conductive layers. The contact hole is formed by a self-aligned etching method, utilizing gate spacers, to provide a sufficient processing margin for the contact plug that connects the conductive layers. In addition, a damascene process is used to form copper metal wiring in the interlayer dielectric. Copper is used because it has a low resistance and a good electro-migration property.

In order to implement the self-aligning method and the damascene process mentioned above, a nitride layer and an oxide layer should be formed on the substrate. However, the forming of the nitride layer and the oxide layer on the intended surface of the substrate also results in the formation of the layers on a bevel (side) portion of the substrate and on a bottom portion of the substrate. These portions of the oxide layer and nitride layer formed on the bevel and bottom portions of the substrate can separate from the substrate during subsequent processes. If this occurs, particles of the nitride layer and the oxide layer can produce a defect that lowers the yield of the semiconductor device manufacturing process.

Furthermore, a monitoring substrate and a dummy wafer are used during a deposition process to control the thickness of the layer being deposited and to improve a property of the lower. The monitoring substrate and the dummy wafer are regenerated through the use of a Decap process or are cast away after having been used several times.

The cost of wafers is significant, and only increases with the size of the wafer. Therefore, the Decap process for regenerating the monitoring substrate and the dummy wafer is an important process for keeping costs to a minimum, especially when large wafers are being used. However, the Decap process can damage the substrate or wafer in the manner described above, i.e., by causing a layer of material to separate from the bevel or bottom portion of the substrate or wafer (hereinafter referred to merely as “substrate”).

In order to eliminate the above-described problems, materials formed at the bevel portion and on the bottom portion of the substrate must be removed. To this end, various cleaning methods utilizing a cleaning solution have been disclosed.

Japanese Laid-Open Patent Publication No. Hei 8-306651 discloses a cleaning composition including 0.15 moles or more of fluoride for cleaning a semiconductor substrate. U.S. Pat. No. 5,709,756 discloses a cleaning solution including hydro-oxyamine and ammonium fluoride for removing an organic material from a substrate.

In addition, Korean Laid-Open Patent Publication No. 2000-061342 discloses a method of removing a polymer and an oxide layer from a substrate using a sulfuric acid boil cleaning solution (H₂SO₄+H₂O₂), a dilute hydrofluoric acid cleaning solution (HF+H₂O) and an SC1 (standard clean 1) cleaning solution.

Japanese Laid-Open Patent Publication No. Hei 8-083792 discloses a composition for etching a silicon nitride layer, the composition having a high etching selectivity with respect to a silicon substrate on which the silicon nitride layer is formed. The composition includes hydrofluoric acid or ammonium fluoride by about 1% by weight or less in a phosphoric acid solution.

However, the disclosed cleaning solutions and cleaning methods will either remove organic materials or polymers present on the semiconductor substrate or a nitride layer. Hence, these solutions and methods can not remove a nitride layer present at the bevel portion of the substrate or on the bottom portion of the substrate without damaging the substrate. In addition, the prior art cleaning solution has an exceedingly low etching rate with respect to a nitride layer. Thus, using this prior art cleaning solution to clean the bevel portion of the substrate or the bottom portion of the substrate would require a great amount of time, thereby presenting a limitation on the throughput that can be achieved by the semiconductor device manufacturing process.

### SUMMARY OF THE INVENTION

An object of the present invention is to overcome the aforementioned problems and limitations of the prior art.

It is thus a general object of the present invention to provide a cleaning solution and cleaning method, which can advantageously and rapidly remove a nitride layer from a substrate without damaging the substrate.

More specifically, one object of the present invention is to provide a method of removing a nitride layer from a bevel portion of a semiconductor substrate rapidly and without damaging the substrate.

Another object of the present invention is to provide a method of removing a nitride layer from a bottom portion of a semiconductor substrate rapidly and without damaging the substrate.

Yet another object of the present invention is to provide a Decap method by which a nitride layer formed on a control substrate can be removed without damaging the substrate.

According to one aspect of the present invention, there is provided a cleaning solution comprising from about 10 to about 35% by weight of hydrogen fluoride (HF), from about 10 to about 35% by weight of ammonium fluoride (NH₄F) and from about 30 to about 80% by weight of de-ionized water (H₂O).

According to another aspect of the present invention, after the cleaning solution is prepared, nitride at a bevel portion of a semiconductor substrate is removed by selectively exposing the bevel portion of the semiconductor substrate to the cleaning solution. Then, the semiconductor substrate is rinsed to remove any cleaning solution remaining on the semiconductor substrate, and the semiconductor substrate is dried.

According to another aspect of the present invention, after the cleaning solution is prepared, nitride at a bottom portion of a semiconductor substrate is removed by dipping the substrate into the cleaning solution. Then, the semiconductor substrate is rinsed to remove any cleaning solution remaining on the semiconductor substrate, and the semiconductor substrate is dried.

According to still another aspect of the present invention, after the cleaning solution is prepared, a nitride layer deposited on a control substrate is removed by dipping the substrate into the cleaning solution. Hence, the underlying layer will not be damaged. Then, the control substrate is rinsed to remove any cleaning solution remaining on the control substrate, and the control substrate is dried.

According to the present invention, a nitride layer or a composite nitride/oxide layer formed at bevel or bottom portions of a semiconductor substrate can be removed without damaging the substrate. Also, a nitride layer formed on a control substrate can be removed rapidly in comparison with the use of a conventional cleaning solution. Therefore, the throughput of the semiconductor device manufacturing process can be removed.

### BRIEF DESCRIPTION OF THE DRAWINGS

The above and other objects, features and advantages of the present invention will become readily apparent from the following detailed description thereof made in conjunction with the accompanying drawings, wherein:

FIG. 1 is a flow chart of one embodiment of a method of removing a nitride layer present at a beveled portion of a substrate, according to the present invention;

FIG. 2 is a flow chart of another embodiment of a method of removing a nitride layer present at a bottom portion of a substrate, according to the present invention; and

FIG. 3 is a flow chart of an embodiment of a method of cleaning a substrate to regenerate the substrate, according to the present invention.

### DETAILED DESCRIPTION OF THE PREFERRED EMBODIMENTS

Hereinafter, embodiments of a cleaning solution and a cleaning method according to the present invention will be described in detail.

The Cleaning Solution

The cleaning solution of the present invention is prepared by diluting hydrofluoric acid (HF) and ammonium fluoride (NH₄F), widely used in the semiconductor processing field, with de-ionized water. It is noted that hydrofluoric acid and ammonium fluoride are main components of LAL solution, which has been conventionally and widely used for removing an oxide layer formed on a semiconductor substrate. In particular, hydrofluoric acid has a good etching rate with respect to oxides, as is well known. Therefore, the cleaning solution of the present invention also has a good etching rate with respect to an oxide layer.

However, even though the cleaning solution of the present invention includes the same components of a conventional LAL solution, the ratio of hydrofluoric acid, ammonium fluoride and de-ionized water in the cleaning solution of the present invention is different from that of the conventional LAL solution. As a result, the cleaning solution of the present invention has a good etching rate with respect to both an oxide and a nitride layer. That is, a nitride layer can be rapidly removed by the cleaning solution without damaging an underlying layer, in contrast to the conventional LAL solution.

Therefore, the cleaning solution of the present invention can rapidly remove a nitride layer, an oxide layer and a composite layer thereof present at bevel an bottom portions of a semiconductor substrate without damaging the substrate. Also, a nitride layer present on a monitoring substrate or a dummy wafer (hereinafter “control substrate”) can be advantageously removed during a Decap process without damaging an underlying layer.

In addition, the viscosity of the cleaning solution of the present invention is lower than that of the phosphoric acid cleaning solution conventionally used to remove a nitride layer. Accordingly, the cleaning solution can be sprayed toward the bevel portion of the substrate using a nozzle having minute spray openings. Furthermore, the cleaning solution can be easily removed using de-ionized water.

The above-described cleaning solution, suitable for removing unnecessary portions of a nitride layer from a substrate, preferably includes about 10-35% by weight of hydrofluoric acid (HF), about 10-35% by weight of ammonium fluoride (NH₄F) and about 30-80% by weight of de-ionized water (H₂O) based on the total amount of the cleaning solution.

If the amount of hydrofluoric acid (HF) in the cleaning solution is less than about 10% by weight of the cleaning solution, the etching rate of the solution with respect to a nitride layer by the cleaning solution is extremely low. Such a solution would not offer the throughput necessary for a commercial process of etching nitride layers in the manufacturing of semiconductor devices. On the other hand, if the amount of hydrofluoric acid (HF) in the cleaning solution is more than about 35% by weight of the cleaning solution, the etching rate of the solution with respect to a nitride layer is sufficiently high; however, the solution would produce an amount of fumes large enough to damage a cleaning apparatus and pose a health risk to workers during the cleaning process.

If the amount of ammonium fluoride (NH₄F) in the cleaning solution is about 10% by weight or less of the cleaning solution, the etching rate of cleaning solution with respect to the nitride layer is exceedingly low because there are simply not enough fluoride ions present in the cleaning solution for etching the nitride layer. On the other hand, if the amount of ammonium fluoride (NH₄F) in the cleaning solution is more than about 35% by weight, there is not a sufficient amount of hydrofluoric acid (HF) in the cleaning solution. Of the components of the cleaning solution, hydrofluoric acid (HF) has the greatest effect on a nitride layer. Thus, again, if the amount of ammonium fluoride (NH₄F) in the cleaning solution were about 10% by weight or less of the cleaning solution, the etching rate of the solution with respect to a nitride layer would be too low to facilitate a satisfactory throughput of the etching (cleaning) process.

If the amount of de-ionized water (H₂O) in the cleaning solution is less than about 30% by weight based on the total amount of the cleaning solution, the amounts of hydrogen fluoride and ammonium fluoride in the cleaning solution are relatively high. Accordingly, the cleaning solution would produce a large amount of fumes, thereby damaging the cleaning apparatus and potentially harming workers during the cleaning process. On the other hand, if the amount of de-ionized water (H₂O) in the cleaning solution is about 80% by weight or more, the relative amounts of hydrogen fluoride and ammonium fluoride included in the cleaning solution are too low, i.e., are so low that there are not enough of the fluoride ions required for the etching of the nitride layer. Therefore, such a cleaning solution could not be used to provide a high enough throughput for the cleaning process.

In addition to the ratio of hydrogen fluoride, ammonium fluoride and de-ionized water, the etching rate of the cleaning solution with respect to a nitride layer is dependent on the temperature of the cleaning solution. More specifically, the cleaning effect with respect to the nitride layer becomes greater as the temperature of the cleaning solution is increased. Therefore, the etching rate of the nitride layer can be effectively controlled by controlling the temperature of the cleaning solution appropriately. The temperature of the cleaning solution when used in a cleaning process of removing a nitride layer is preferably in a range of from about 15° C. to about 35° C., and more preferably, from about 20° C. to about 30° C. If the temperature of the cleaning solution is less than about 15° C., the rate at which the solution can remove a nitride layer or nitride/oxide layers present on the substrate is too low and when the temperature of the cleaning solution exceeds about 35° C., the fumes generated can damage the cleaning apparatus and harm workers.

The Method of Cleaning a Substrate

The present invention is particularly aimed at removing a nitride layer or an oxide/nitride layer present on a substrate. According to the present invention, the term oxide/nitride layer refers to a composite in which an oxide layer is formed on a nitride layer or vice versa.

First, a cleaning solution is prepared. As described above, the cleaning solution includes about 10 to about 35% by weight of hydrogen fluoride, about 10 to about 35% by weight of ammonium fluoride and about 30 to about 80% by weight of de-ionized water. After that, the substrate is dipped into the cleaning solution of the present invention or the cleaning solution is dispensed, e.g., sprayed, onto a portion of the substrate to remove the nitride layer or the oxide/nitride layer present thereon. In the latter case, the portion of the substrate subjected to the cleaning solution may be the bevel (side edge) portion of the substrate, a bottom portion of the substrate or an upper portion of a substrate. The temperature of the cleaning solution is preferably in the range of about 15 to about 35° C., and more preferably in the range of about 20 to about 30° C.

If the temperature of the cleaning solution is less than about 15° C., a long period of time is required for removing the nitride layer from the substrate. If the temperature of the cleaning solution is over about 35° C., the nitride layer can be removed rapidly but the cleaning solution can damage the cleaning apparatus (bath) and it becomes very difficult to control the etching process to prevent the layer underneath the nitride layer from being damaged.

Next, the substrate is dipped into de-ionized water to rinse remaining cleaning solution from the substrate. Then the substrate is dried.

The above-described method can be used to effectively remove a nitride layer and a nitride/oxide layer from a select portion of the substrate to prevent the layers from producing particles during subsequent semiconductor processes and hence, to prevent defects in the resultant semiconductor devices.

In addition, a nitride layer present on a monitoring substrate and a dummy wafer (control substrates) can be rapidly removed without damaging an underlying layer. Therefore, the lifetimes of such substrates can be prolonged, and Decap processing time can be minimized.

The preferred embodiments of the cleaning method according to the present invention will now be described in more detail.

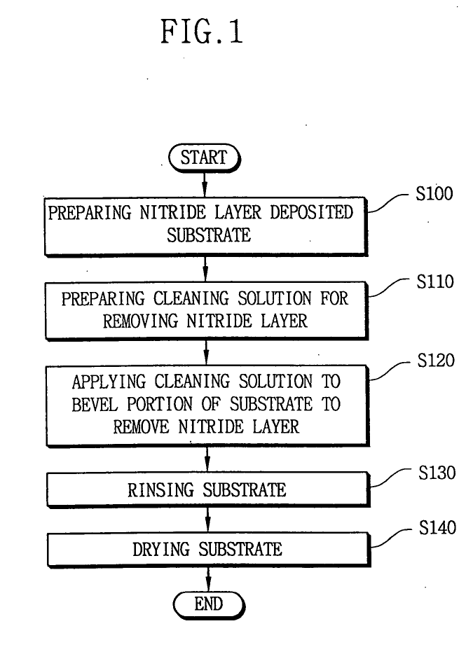

Referring to FIG. 1, a nitride layer or a nitride layer/oxide layer is formed in a predetermined pattern on a substrate (step S100). This step leaves a portion of the nitride layer on the bevel portion of the substrate as well as on the top surface of the substrate.

Then, a cleaning solution including about 10 to about 35% by weight of hydrogen fluoride (HF), about 10 to about 35% by weight of ammonium fluoride (NH₄F) and about 30 to about 80% by weight of de-ionized water (H₂O) based on the total amount of the cleaning solution is prepared (step S110).

The cleaning solution is applied to remove the nitride layer present at the bevel portion of the substrate (step S120). At this time, the temperature of the cleaning solution is kept to about 15 to about 30° C.

The removal of the nitride layer from the bevel portion of the substrate is carried out as follows.

1) A photoresist film is formed on the substrate to leave only the nitride layer at the bevel portion exposed. Then, the substrate is immersed in the cleaning solution for a predetermined period to remove the nitride layer from the bevel portion of the substrate.

2) Alternatively, the cleaning solution is sprayed onto the bevel portion of the substrate through a nozzle while rotating the substrate. The nitride layer present at the bevel portion of the substrate is thus removed by providing the cleaning solution only on the bevel portion of the substrate for a given time. This technique is applicable because the viscosity of the cleaning solution of the present invention is sufficiently low, i.e., lower than that of a conventional phosphoric-acid based aqueous cleaning solution. Also, the throughput is relatively high compared to when the above-described technique (1) is implemented because s this technique does not require the forming of a photoresist film on the substrate.

After the nitride layer has been removed from the bevel portion of the substrate, any cleaning solution remaining on the substrate is rinsed away using de-ionized water. Then, a drying process is performed to remove the de-ionized water from the substrate (steps S130 and S140).

According to the cleaning methods described-above, the nitride layer or the nitride layer/oxide layer present at the bevel portion, which layer is liable to produce particles, can be advantageously and rapidly removed without damaging the substrate. In addition, the cleaning process can be completed in a short time.

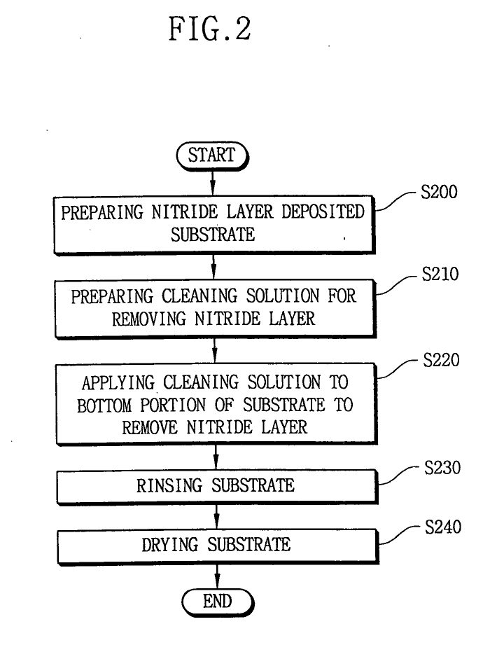

FIG. 2 illustrates another embodiment of the cleaning method according to the present invention.

Referring to FIG. 2, a substrate is prepared. To this end, a deposition process is carried out to form a nitride layer or an oxide/nitride layer in a predetermined pattern (step S200). This step leaves a portion of the nitride layer on a bottom portion of the substrate as well as on the top of the substrate where the pattern is formed.

Then, a cleaning solution including about 10 to about 35% by weight of hydrogen fluoride (HF), about 10 to about 35% by weight of ammonium fluoride (NH₄F) and about 30 to about 80% by weight of de-ionized water (H₂O) based on the total amount of the cleaning solution is prepared (step S210).

The cleaning solution is applied to remove the nitride layer present at the bottom portion of the substrate (step S220). At this time, the temperature of the cleaning solution is kept to about 15 to about 30° C.

The removal of the nitride layer from the bevel portion of the substrate is carried out as follows. A photoresist film is formed on the top of the substrate to leave the nitride layer at the bottom portion exposed. Then, the substrate is immersed in the cleaning solution for a predetermined period to remove the nitride layer from the bottom portion of the substrate.

After the nitride layer has been removed from the bottom portion of the substrate, any cleaning solution remaining on the substrate is rinsed away using de-ionized water. Then, a drying process is performed to remove the de-ionized water from the substrate (steps S230 and S240).

According to the cleaning methods described-above, the nitride layer or the nitride layer/oxide layer present at the bottom portion, which layer is liable to produce particles, can be advantageously and rapidly removed without damaging the substrate. In addition, the cleaning process can be completed in a short time.

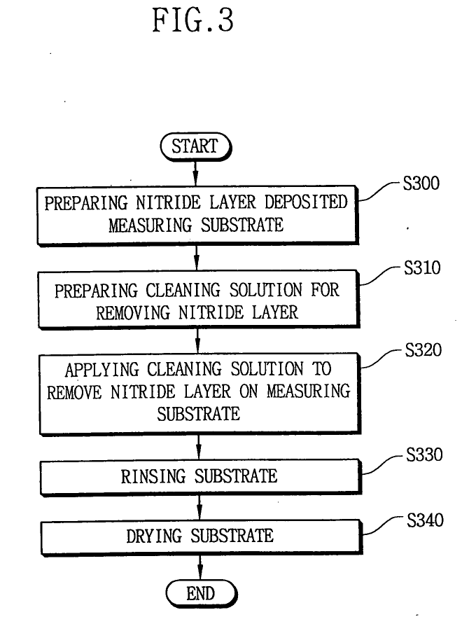

FIG. 3 illustrates a method of regenerating a control substrate according to the present invention.

Referring to FIG. 3, a deposition process is carried out to form a nitride layer in a predetermined pattern on a monitoring substrate or a dummy wafer (step S300).

As mentioned above, the monitoring substrate or the dummy wafer is a control substrate that is judged to determine whether a layer formed by the deposition process has a uniform thickness or an otherwise satisfactory property. The control substrate is regenerated through a Decap process after it has been used several times. However, repeating the Decap process for regenerating the control substrate risks damaging the layers beneath those that are targeted for removal. This risk is mitigated by the present invention.

A cleaning solution including about 10 to about 35% by weight of hydrogen fluoride (HF), about 10 to about 35% by weight of ammonium fluoride (NH₄F) and about 30 to about 80% by weight of de-ionized water (H₂O) based on the total amount of the cleaning solution is prepared (step S310).

The control substrate is dipped into the cleaning solution for a predetermined period of time to remove the nitride layer present on the control substrate without damaging the underlying layer (step S320). At this time, the temperature of the cleaning solution is kept to about 15 to about 30° C.

After the nitride layer has been removed from the control substrate, any cleaning solution remaining on the substrate is rinsed away using de-ionized water. Then, a drying process is performed to remove the de-ionized water from the substrate (steps S330 and S340).

By employing the above-described cleaning as the Decap process, the nitride layer present on the control substrate can be advantageously and rapidly removed without damaging the underlying layer. In addition, the Decap process can be completed in a short amount of time.

### TEST EXAMPLE 1

The rates at which similar nitride layers were etched by cleaning solutions were observed for various ratios of hydrogen fluoride, ammonium fluoride and de-ionized water in the cleaning solutions, and for various temperatures of the cleaning solutions.

Each of the tests was carried out by dipping a silicon substrate, on which a nitride layer having a thickness of about 1800Å was formed, into the cleaning solution having a respective ratio of components and a predetermined temperature for 10 minutes. After that, the substrate was rinsed using de-ionized water, and then the substrate was dried. The thickness of the original nitride layer formed on the silicon substrate (layer) and the thickness of the remaining nitride layer were recorded.

The results are illustrated in Table 1. Note, in the result column, (⊚ represents excellent, ◯ represents good, Δ represents average, and X represents poor. Specifically, the substrates rated ⊚ and ◯ in Table 1 were those in which only silicon (Si) was observed after the cleaning test. On the contrary, the substrates rated Δ and X in Table 1 were those in which both silicon (Si) and nitrogen (N) were observed after the cleaning test.

TABLE 1

| | Temp. of | | |
|---|---|---|---|
| Mixing ratio of | cleaning | Etching rate | Result |
| HF:NH₄F:H₂O (wt %) | solution (° C.) | (□/min) | (10 min cleaning) |
| 20:0:80 | 20 | 120 | X |
| 25:10:65 | 20 | 250 | Δ |
| 25:20:55 | 20 | 300 | ◯ |
| 13:17:70 | 20 | 140 | X |
| 17:27:56 | 20 | 150 | Δ |
| 20:0:80 | 30 | 250 | ◯ |
| 25:10:65 | 30 | 300 | ⊚ |
| 25:20:55 | 30 | 500 | ⊚ |

Referring to Table 1, when the temperature of the cleaning solution is about 30° C., the etching rate of the nitride layer is two times that or greater than the etching rate which is achieved when the temperature of the same composition of cleaning solution is used at about 20° C. The results thus show that the etching rate is even more dependent on the temperature of the cleaning solution than on the wt % ratio of the components in the cleaning solution.

In addition, the etching rate is higher for those compositions having a greater relative amount of hydrogen fluoride, under the same temperature conditions. The test results also show the etching rate to be higher for those compositions having a greater amount of ammonium fluoride given equal amounts of hydrogen fluoride.

As described above, a nitride layer or a oxide/nitride layer formed at the bevel portion of a semiconductor substrate and at the bottom portion of the substrate can be removed without damaging the substrate when using the cleaning solution of the present invention. In addition, the nitride layer can be removed more rapidly when using the cleaning solution of the present invention than when using a conventional phosphoric acid cleaning solution. Therefore, the present invention offers an improvement in the throughput of the semiconductor device manufacturing process.

Furthermore, a nitride layer formed on an upper portion of a monitoring substrate can be removed by the cleaning solution of the present invention without damaging the substrate during a Decap processing for regenerating the monitoring substrate. Therefore, the costs associated with this aspect of the semiconductor device manufacturing process can be minimized.

Although the embodiments of the present invention have been described in detail above, the present invention is not so limited. Rather, various changes to and modifications of the preferred embodiments are seen to be within the true spirit and scope of the present invention as hereinafter claimed.

What is claimed is:

1. A cleaning solution comprising from about 10% to about 35% by weight of hydrogen fluoride (HF), from about 10% to about 35% by weight of ammonium fluoride (NH₄F) and from about 30% to about 80% by weight of de-ionized water (H₂O) based on a total amount of the cleaning solution.

2. A method of cleaning a semiconductor substrate, comprising:
providing a substrate having a top surface, a bottom surface and a bevel portion constituting a side edge extending between said top and bottom surfaces, and a layer comprising a nitride that extends over said top surface and onto said bevel portion;
preparing a cleaning solution comprising from about 10% to about 35% by weight of hydrogen fluoride (HF), from about 10% to about 35% by weight of ammonium fluoride (NH₄F) and from about 30% to about 80% by weight of de-ionized water (H₂O) based on a total amount of the cleaning solution;
selectively exposing the bevel portion of the substrate to the cleaning solution to thereby remove the layer from the bevel portion while leaving the layer on the top surface;
subsequently rinsing the substrate of cleaning solution remaining on the semiconductor substrate; and
subsequently drying the substrate.

3. The method of cleaning a semiconductor substrate of claim 2, further comprising maintaining the temperature cleaning solution in a range of from about 15° C. to about 35° C. while the cleaning solution is removing the layer from the bevel portion.

4. The method of cleaning a semiconductor substrate of claim 2, wherein said exposing comprises spraying the cleaning solution toward the bevel portion of the substrate through a nozzle.

5. The method of cleaning a semiconductor substrate of claim 2, wherein the layer includes a nitride layer.

6. The method of cleaning a semiconductor substrate of claim 2, wherein the layer comprises an oxide layer, and a nitride layer disposed on the oxide layer.

7. The method of cleaning a semiconductor substrate of claim 2, wherein the layer comprises a nitride layer, and an oxide layer disposed on the oxide layer.

8. A method of cleaning a semiconductor substrate comprising:
providing a substrate having a top surface, a bottom surface and a bevel portion constituting a side edge extending between said top and bottom surfaces, and a layer comprising a nitride that extends over said top surface and onto said bottom portion;
preparing a cleaning solution comprising from about 10% to about 35% by weight of hydrogen fluoride (HF), from about 10% to about 35% by weight of ammonium fluoride (NH₄F) and from about 30% to about 80% by weight of de-ionized water (H₂O) based on a total amount of the cleaning solution;
removing the layer from the bottom portion of the substrate by dipping the substrate into the cleaning solution;
subsequently rinsing the substrate of cleaning solution remaining on the semiconductor substrate; and
subsequently drying the substrate.

9. The method of cleaning a semiconductor substrate of claim 8, further comprising maintaining the temperature cleaning solution in a range of from about 15° C. to about 35° C. while the cleaning solution is removing the layer from the bottom portion.

10. The method of cleaning a semiconductor substrate of claim 8, wherein one of a nitride layer, a composite layer of an oxide layer/nitride layer and a composite layer of a nitride layer/oxide layer is formed on the semiconductor substrate, and a photoresist film is formed on the substrate.

11. The method of cleaning a semiconductor substrate of claim 8, wherein the layer includes of a nitride layer.

12. The method of cleaning a semiconductor substrate of claim 8, wherein the layer comprises an oxide layer, and a nitride layer disposed on the oxide layer.

13. The method of cleaning a semiconductor substrate of claim 8, wherein the layer comprises a nitride layer, and an oxide layer disposed on the oxide layer.

14. A method of cleaning a substrate comprising:
providing a substrate having a top surface, and a nitride layer that extends over said top surface;
preparing a cleaning solution comprising from about 10% to about 35% by weight of hydrogen fluoride (HF), from about 10% to about 35% by weight of ammonium fluoride (NH₄F) and from about 30% to about 80% by weight of de-ionized water (H₂O) based on a total amount of the cleaning solution;
removing the nitride layer from the substrate without damaging the layer underlying the nitride layer, by dipping the substrate into the cleaning solution;
subsequently rinsing the substrate of cleaning solution remaining on the semiconductor substrate; and
subsequently drying the substrate.

15. The method of cleaning a substrate of claim 14, further comprising maintaining the temperature cleaning solution in a range of from about 15° C. to about 35° C. while the cleaning solution is removing the nitride layer.

16. The method of cleaning a substrate of claim 15, wherein said removing constitutes a Decap process for regenerating the substrate.

17. A method for use in the manufacturing of semiconductor devices, comprising:
providing a control substrate;
forming a nitride layer a plurality of times on the control substrate;
determining a characteristic of the nitride layer after each time a said nitride layer is formed on the control substrate;
regenerating the substrate between respective ones of the plurality of times in which the nitride layers are formed on the substrate by
preparing a cleaning solution comprising from about 10% to about 35% by weight of hydrogen fluoride (HF), from about 10% to about 35% by weight of ammonium fluoride (NH₄F) and from about 30% to about 80% by weight of de-ionized water (H₂O) based on a total amount of the cleaning solution, and
removing the nitride layer from the substrate by dipping the substrate into the cleaning solution.
